(19) United States
(12) Patent Application Publication
(10) Pub. No.: US 2002/0158517 A1
(43) Pub. Date: Oct. 31, 2002

(54) Method and apparatus for turbogenerator anti-surge control

(76) Inventors: Gregory C. Rouse, Westlake Village, CA (US); Mark Gilbreth, Simi Valley, CA (US); Daniel DeMore, Tarzana, CA (US); William Treece, La Mesa, CA (US)

Correspondence Address: IRELL & MANELLA LLP, 1800 Avenue of the Stars, Suite 900, Los Angeles, CA, 90067, US

(21) Appl. No.: 10/002,985

(22) Filed: Nov. 14, 2001

Related U.S. Application Data
(60) Provisional application No. 60/248,292, filed on Nov. 14, 2000.

(51) Int. Cl. H02M 1/00

(52) U.S. Cl. 307/151

(57) ABSTRACT

A turbogenerator system including a compressor rotationally coupled to a turbine and a bleed valve connected to the compressor discharge to vent a portion of the compressed air when the turbogenerator speed is within a preselected range to prevent the compressor from stalling. The turbogenerator speed is controlled to provide a required amount of power, and the turbine exit temperature is controlled in accordance with different functions of turbogenerator speed and ambient conditions to maintain an air flow that will prevent compressor from stalling, the function selected in accordance with whether the bleed valve is open of closed.

### RELATED APPLICATIONS

This patent application claims the priority of provisional patent application serial number 60/248,292, filed Nov. 14, 2000.

### BACKGROUND OF THE INVENTION

A turbogenerator electric power generation system is generally comprised of a compressor, a turbine and an electrical generator rotationally coupled together, and a combustor for combusting fuel and compressed air. Small turbogenerators are generally designed with fixed geometry components such as compressor and turbine inlets, and must therefore be designed for maximum efficiency at a selected speed which is typically at or near the maximum speed. As the speed changes towards or away from the maximum speed, conditions of surge may be encountered where the compressor may surge (i.e. stall) due to increased back pressure from the compressor and turbine. What is needed is a method and apparatus for preventing compressor surge in a fixed-geometry turbogenerator system.

### SUMMARY OF THE INVENTION

In one aspect, the present invention provides a method of operating a turbogenerator to provide a varying amount of power, the turbogenerator having an air compressor rotationally coupled to a turbine, the method comprising controlling turbogenerator speed to provide the required amount of power, controlling air flow through the turbine inlet to prevent the compressor from stalling by venting a portion of the compressor output while the turbogenerator speed is between a predetermined lower surge value and a predetermined upper surge value, and controlling the turbine exit temperature to a value derived as a function of turbogenerator speed and ambient conditions to maintain the required air flow.

In another aspect, the present invention provides a turbogenerator system comprising a turbine driven by hot gas, a combustor for combusting fuel and compressed air to generate the hot gas, an air compressor rotationally coupled to the turbine to provide the compressed air, a bleed valve connected to the compressor discharge to vent a selectable portion of the compressed air while the turbogenerator speed is between a predetermined lower surge value and a predetermined upper surge value to prevent the compressor from stalling, and a controller for controlling turbogenerator speed to provide a required amount of power, controlling the bleed valve to maintain a required airflow through the turbine inlet, and controlling the turbine exit temperature to a value derived as a function of turbogenerator speed and ambient conditions.

In a further aspect, the temperature may be controlled in accordance with a function selected based on whether the bleed valve is open or closed. The turbogenerator combustor may also include a plurality of injectors, and fuel and air may be selectively provided through any one or more of the injectors to maintain a selected air-to-fuel ratio in the combustor.

### BRIEF DESCRIPTION OF THE DRAWINGS

FIG. 1 is perspective view, partially in section, of a turbogenerator system according to the present invention;

FIG. 2 is a functional diagram showing the turbogenerator of FIG. 1 and an associated power controller;

FIG. 3 is a generic compressor map illustrating operating and surge characteristics for the turbogenerator of FIG. 1;

FIG. 4 is a schematic diagram illustrating airflow for one embodiment of a turbogenerator with anti-surge control according to the present invention; and

FIG. 5 is a block diagram illustrating one embodiment of a fuel control strategy for a turbogenerator with anti-surge control according to the present invention.

### DETAILED DESCRIPTION OF THE INVENTION

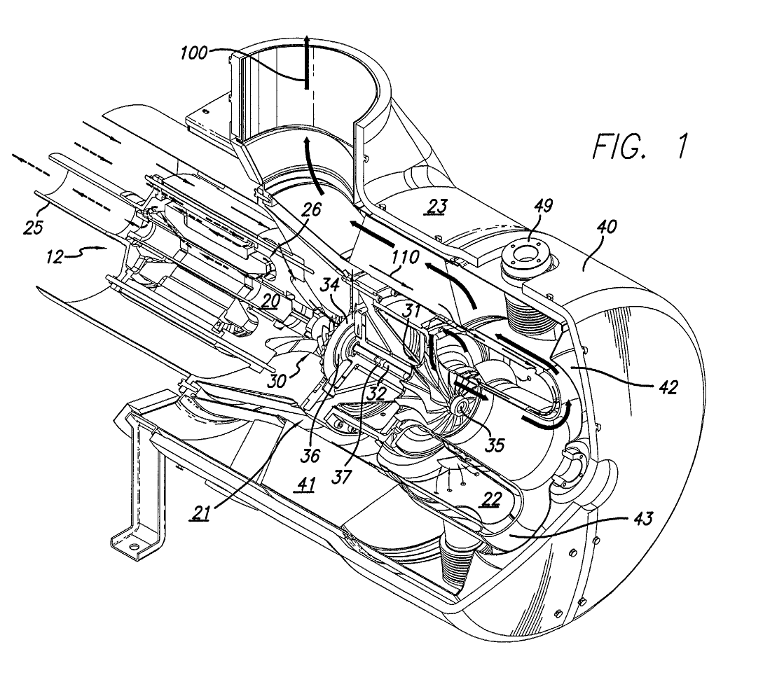

Referring to FIG. 1, integrated turbogenerator system 12 generally includes motor/generator 20, power head 21, combustor 22, and recuperator (or heat exchanger) 23. Power head 21 of turbogenerator 12 includes compressor 30, turbine 31, and common shaft 32. Tie rod 33 to magnetic rotor 26 (which may be a permanent magnet) of motor/generator 20 passes through bearing rotor 32. Compressor 30 includes compressor impeller or wheel 34 that draws air flowing from an annular air flow passage in outer cylindrical sleeve 29 around stator 27 of the motor/generator 20. Turbine 31 includes turbine wheel 35 that receives hot exhaust gas flowing from combustor 22. Combustor 22 receives preheated air from recuperator 23 and fuel through a plurality of fuel injector guides 49. Compressor wheel 34 and turbine wheel 35 are supported on common shaft or rotor 32 having radially extending air-flow bearing rotor thrust disk 36. Common shaft 32 is rotatably supported by a single air-flow journal bearing within center bearing housing 37 while bearing rotor thrust disk 36 at the compressor end of common shaft 32 is rotatably supported by a bilateral air-flow thrust bearing.

Motor/generator 20 includes magnetic rotor or sleeve 26 rotatably supported within generator stator 27 by a pair of spaced journal bearings. Both rotor 26 and stator 27 may include permanent magnets. Air is drawn by the rotation of rotor 26 and travels between rotor 26 and stator 27 and further through an annular space formed radially outward of the stator to cool generator 20. Inner sleeve 25 serves to separate the air expelled by rotor 26 from the air being drawn in by compressor 30, thereby preventing preheated air from being drawn in by the compressor and adversely affecting the performance of the compressor (due to the lower density of preheated air as opposed to ambient-temperature air).

In operation, air is drawn through sleeve 29 by compressor 30, compressed, and directed to flow into recuperator 23. Recuperator 23 includes annular housing 40 with heat transfer section or core 41, exhaust gas dome 42, and combustor dome 43. Heat from exhaust gas 110 exiting turbine 31 is used to preheat compressed air 100 flowing through recuperator 23 before it enters combustor 22, where the preheated air is mixed with fuel and ignited such as by electrical spark, hot surface ignition, or catalyst. The fuel may also be premixed with all or a portion of the preheated air prior to injection into the combustor. The resulting combustion gas expands in turbine 31 to drive turbine impeller 35 and, through common shaft 32, drive compressor 30 and rotor 26 of generator 20. The expanded turbine exhaust gas then exits turbine 31 and flows through recuperator 23 before being discharged from turbogenerator 12.

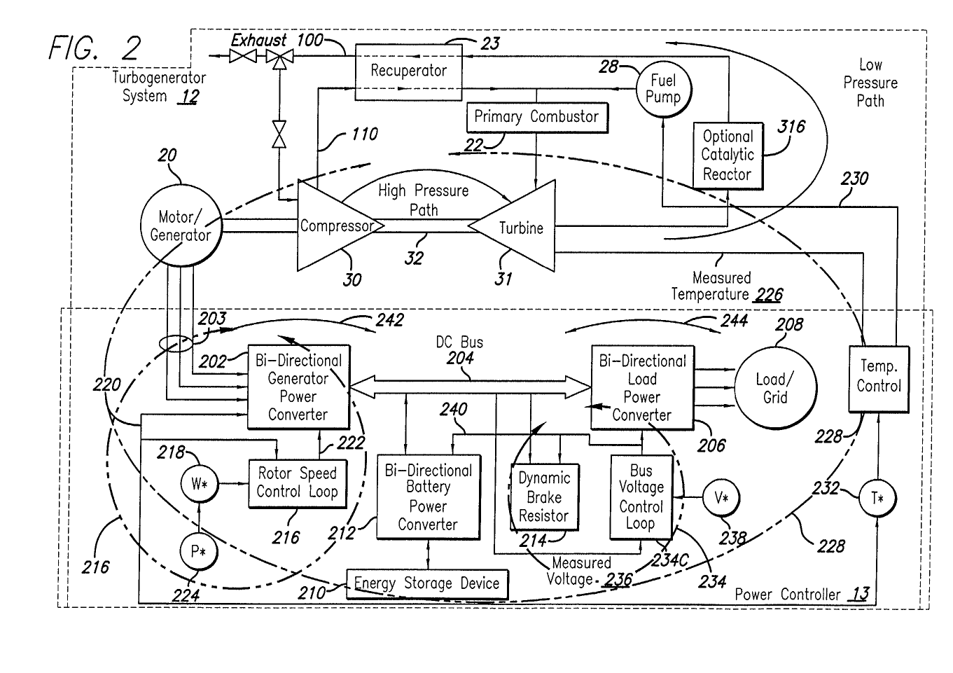

Referring now to FIG. 2, integrated turbogenerator system 12 includes power controller 13 with three substantially decoupled control loops for controlling (1) rotary speed, (2) temperature, and (3) DC bus voltage. A more detailed description of an appropriate power controller is disclosed in co-pending U.S. patent application Ser. No. 09/207,817, filed Dec. 8, 1998 in the names of Gilbreth, Wacknov and Wall, assigned to the assignee of the present application, and incorporated herein in its entirety by reference.

Temperature control loop 228 regulates a temperature related to the desired operating temperature of combustor 22 to a set point by varying fuel flow from fuel pump 46 to the combustor. Temperature controller 228C receives a temperature set point T* from temperature set point source 232 and receives a measured temperature from temperature sensor 226S via measured temperature line 226. Temperature controller 228C generates and transmits a fuel control signal to fuel pump 50P over fuel control signal line 230 for controlling the amount of fuel supplied by fuel pump 46 to combustor 22 to an amount intended to result in a desired operating temperature in the combustor. Temperature sensor 226S may directly measure the temperature in combustor 22 or may measure a temperature of an element or area from which the temperature in the combustor may be inferred.

Speed control loop 216 controls the speed of common shaft 32 by varying the torque applied by motor/generator 20 to the common shaft. Torque applied by the motor/generator to the common shaft depends upon power or current drawn from or supplied to windings of motor/generator 20. Bi-directional generator power converter 202 is controlled by rotor speed controller 216C to transmit power or current in or out of motor/generator 20, as indicated by bi-directional arrow 242. A sensor in turbogenerator 12 senses the rotary speed of common shaft 32, such as by measuring the frequency of motor/generator 20 power output and determining the speed based upon this measured frequency, and transmits a rotary speed signal over measured speed line 220. Rotor speed controller 216 receives the rotary speed signal from measured speed line 220 and a rotary speed set point signal from a rotary speed set point source 218. Rotary speed controller 216C generates and transmits to generator power converter 202 a power conversion control signal on line 222 controlling the transfer of power or current between AC lines 203 (i.e., from motor/generator 20) and DC bus 204 by generator power converter 202. Rotary speed set point source 218 may convert a power set point P* received from power set point source 224 to the rotary speed set point.

Voltage control loop 234 controls bus voltage on DC bus 204 to a set point by transferring power or voltage between DC bus 204 and any of (1) load/grid 208 and/or (2) energy storage device 210, and/or (3) by transferring power or voltage from DC bus 204 to dynamic brake resistor 214. A sensor measures voltage DC bus 204 and transmits a measured voltage signal over measured voltage line 236 to bus voltage controller 234C, which further receives a voltage set point signal V* from voltage set point source 238. Bus voltage controller 234C generates and transmits signals to bi-directional load power converter 206 and bi-directional battery power converter 212 controlling their transmission of power or voltage between DC bus 204, load/grid 208, and energy storage device 210, respectively. In addition, bus voltage controller 234 transmits a control signal to control connection of dynamic brake resistor 214 to DC bus 204.

Power controller 13 regulates temperature to a set point by varying fuel flow, controls shaft speed to a set point (indicated by bi-directional arrow 242) by adding or removing power or current to/from motor/generator 20 under control of generator power converter 202, and controls DC bus voltage to a set point by (1) applying or removing power from DC bus 204 under the control of load power converter 206 as indicated by bi-directional arrow 244, (2) applying or removing power from energy storage device 210 under the control of battery power converter 212, and (3) by removing power from DC bus 204 by modulating the connection of dynamic brake resistor 214 to DC bus 204.

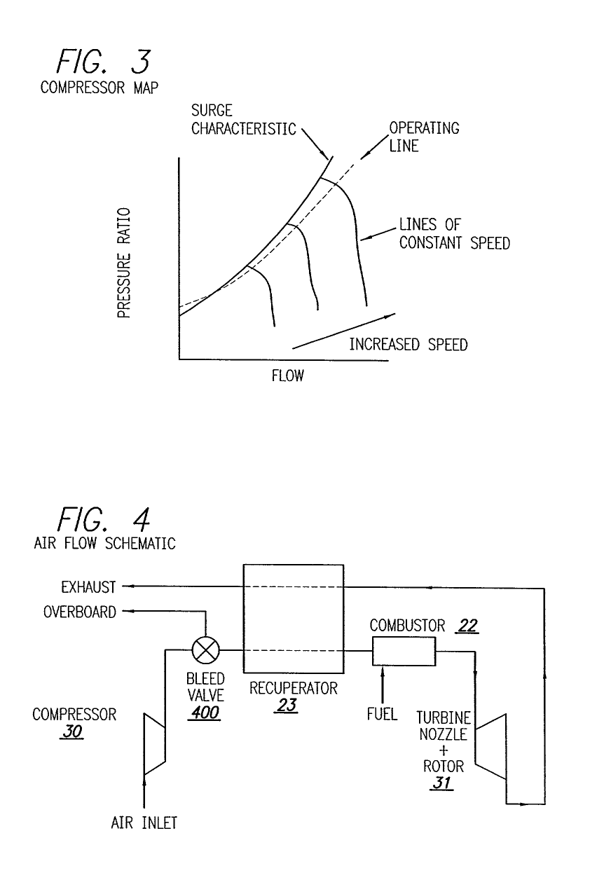

With reference to FIG. 3, compressor 30 has surge (i.e. stall) characteristics such that if the pressure ratio becomes too high, the airflow will become unstable and back flow through the compressor. Surge or stall is analogous to an aircraft wing stalling when the angle of attack exceeds a stable value. The compressor also has a dependent set of flow versus pressure ratio characteristics for each unique compressor rotational speed. When plotted, these characteristics form a compressor map as shown in FIG. 3 that may be used to determine and illustrate the compressor desired operating range and to determine a surge characteristic or “surge line.” Any attempt to operate the compressor stage on the left side of the surge characteristic will result in compressor surge or stall.

In addition to the operating characteristic associated with compressor 30, turbogenerator 12 has an associated operating characteristic that is a function of the aerodynamic geometry of the turbine engine and associated operating conditions, such as inlet temperature, inlet pressure, turbine inlet temperature, turbine inlet pressure, and mass flow. This operating characteristic illustrates the locus of points at which the compressor will operate in the gas turbine engine. To control cost, turbogenerator 12 may be generally designed with fixed geometry aerodynamic components. More expensive and complex engines may use variable geometry compressor inlet guide vanes or turbine inlet guide vanes to prevent the engine operating characteristic from crossing over the surge characteristic and thereby avoiding compressor surge. Such compressor inlet guide vanes can be used to shift the surge characteristic away from the turbine operating characteristic and provide an improved operating range. Likewise, turbine inlet guide vanes (sometimes called nozzles) can be used to shift the engine operating line away from the surge line.

To maximize the full power performance of the engine, it is desirable to operate the engine with the operating characteristic as close to the surge line as possible without crossing the line and resulting in compressor surge. To account for manufacturing variability, transient engine loading and off-loading conditions, and other contingencies, a certain margin is typically allowed for between the operating characteristic and the surge characteristic, usually on the order of five to ten percent as dictated by the engine application. While the surge margin might be acceptable at full speed or full power engine conditions in a fixed geometry engine, the operating characteristic may cross over the surge characteristic at lower engine speeds resulting in compressor surge. Surge margin is understood to mean

$$( 1 - \frac{{PR}_{operating}}{{PR}_{surge}} \times \frac{{flow}_{surge}}{{flow}_{operating}} ) \times 100 \%$$

where PR means pressure ratio.

To prevent the operating line from crossing the surge characteristic, the turbine nozzle inlet temperature (TIT) may be reduced at operating conditions with low surge margin. In a fixed geometry engine, the airflow is generally controlled by the turbine nozzle flow area. Reducing the turbine nozzle inlet temperature reduces the pressure drop across the turbine and thereby shifts the operating line away from the surge line on the compressor map. However, because turbogenerator 12 includes recuperator 23, it is difficult to change the turbine nozzle inlet temperature as quickly as needed to prevent surge when loading and off loading the engine to follow a desired load demand as required by the engine control software. This is because the recuperator acts as a thermal storage device and when the turbine nozzle inlet temperature needs to be reduced quickly, the recuperator gives off heat that may increase the turbine nozzle temperature above what is desired. Consequently, fuel flow to the combustor needs to be reduced to compensate for the heat energy discharged by the recuperator. However, at some point the combustor fuel flow may hit a minimum fuel limit that can cause the combustor to flame out from running too lean. Alternatively, if the fuel flow starts to drop below the minimum fuel limit, the engine control software may maintain the fuel flow at constant flow rate to prevent combustor flame-out. This, however, can result in a higher than desired TIT and surge may occur.

Referring to FIG. 4, bleed valve 400 may be placed downstream of the compressor 30 discharge to bleed flow from the compressor discharge and prevent surge. Bleed valve 400 allows compressor discharge air to bypass the turbine 31 nozzle so that more air can be discharged from the compressor. Allowing more air to flow through the compressor for a given speed will shift the operating line away from the surge line on the compressor map as shown in FIG. 3. The bleed valve may optionally be used in conjunction with a restricting orifice sized to ensure that the bleed valve can never discharge all of the compressor output, thereby inadvertently starving the combustor of air.

Actuation of bleed valve 400 may affect other operating variables. For example, if the engine is operated at a constant speed or constant power level while the bleed valve is opened, TIT will increase to maintain the same speed or power. An increase in TIT results in an increase in turbine exit temperature (TET) which may affect engine control when using the turbine exit temperature as an engine control parameter.

Controller 13 must therefore control bleed valve 400 in concert with other turbogenerator 12 variables. Doing so will enable turbogenerator to follow a varying load over a wide range of power/speed while avoiding compressor surge and combustor flame-out. Controller 13 controls a fuel flow valve and multiple fuel injectors to regulate the temperature of the turbogenerator. A temperature control point may be established based on the speed of the engine and ambient conditions, and modulation of the fuel flow valve then performed to maintain the selected temperature. Turbogenerator 12 may include a plurality of injectors disposed in different injection planes that may be selectively operated or switched to provide fuel to the combustor as dictated by the speed, desired TET, and minimum AFR required to prevent combustor flame-out. The controller may thus further switch the fuel injectors to provide fuel based on referred generator power, which provides a good approximation of the turbogenerator Air-to-Fuel Ratio (AFR).

To maintain control of the turbogenerator when bleed valve 400 is modulated, controller 13 may include different temperature control points and injector switch points based on the position of the bleed valve. Switching the bleed valve on and off may cause radical changes to the airflow within the turbogenerator that may significantly affect the AFR or stability operating point of the combustion reaction. To avoid rapid changes in fuel flow, the controller may employ one temperature control point curve for when the bleed valve is disabled (i.e. shut) and a different curve for when it is enabled (i.e. open). Similarly, to properly correlate AFR to injector switch points, one set of generator power switch points may be used when the bleed valve is disabled and a different set for then the bleed valve is enabled.

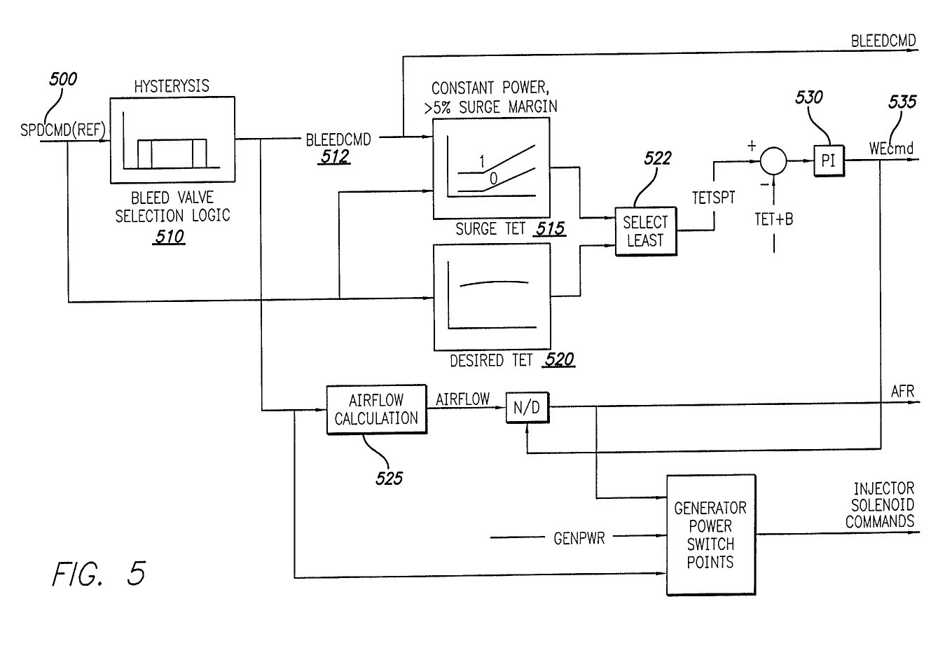

Referring to FIG. 5, conditions of compressor surge are primarily based on airflow through the turbine inlet nozzle. Airflow can be directly correlated to the referred (i.e. adjusted for ambient conditions) speed 500 of the turbogenerator. It is this referred speed 500 that may be used to enable or disable the bleed valve via logic 510 to adjust turbine airflow. A safety margin may also be added when enabling and disabling the bleed valve to prevent cycling by providing two speeds (low and high) when the bleed valve is enabled and two speeds (low and high) when the bleed valve is disabled. In one, non-exclusive example offered for illustrative examples only, when the turbogenerator is accelerating the bleed valve may be opened when 55% of maximum speed is reached and closed again once the speed has accelerated above 75% of maximum. In a similarly illustrative example, when the turbogenerator is slowing down the bleed valve may be opened when 70% of maximum speed is reached and closed when the speed drops below 40% of maximum. A safety margin of approximately 5% may be provided to prevent bleed valve cycling so that, for example, if the bleed valve opens at 55% speed while accelerating and the speed begins to drop, the bleed valve would not be closed again until the speed drops below 50%. The safety margin would typically be applied to all four bleed valve speed control set points. Once bleed valve command 512 (open or close) has been established, controller 13 can make further decisions based on the known airflow 525 through the turbogenerator.

The desired TET setpoint of the engine may be looked up 520 as a function of turbogenerator speed 500. TET surge control 515 may then be based on two functions or curves (0 and 1) to maintain a constant referred speed to power ratio based on the bleed valve position 512. When the bleed valve is disabled, a TET surge control point may be determined as function 0 of referred speed providing a baseline power to speed relationship. When the bleed valve is enabled, less airflow will pass through the turbine wheel requiring higher TET to maintain the same engine power. A relatively higher TET surge control point may then be determined through function 1 of referred speed to provide an equivalent power for the given speed. The TET control point for the engine may then determined by selecting 522 the lower of the Desired TET 520 and the Surge TET 515 values. This TET control may be used as an input to Proportional-Integral control 530 to determine fuel control command 535. One set of possible TET control curves for a 60KW turbogenerator according to the invention are tabulated below.

Bleed Valve Closed

| | | Surge | | |
|---|---|---|---|---|
| | TET | TET/Theta | Generator | Inverter |
| % Speed | (F) | (F) | Power | Power |
| <55 | 1175 | 935 | | |
| 55 | 1175 | 935 | 3.0 | 2.8 |
| 60 | 1175 | — | 4.8 | 4.5 |
| 65 | 1175 | — | 7.4 | 6.9 |
| 70 | 1175 | 935 | 11.1 | 10.3 |
| 75 | 1175 | 935 | 15.9 | 14.8 |
| 80 | 1175 | 1075 | 27.3 | 25.4 |
| 85 | 1175 | 1175 | 39.1 | 36.4 |
| 90 | 1175 | 1175 | 47.5 | 44.2 |
| 95 | 1175 | 1175 | 56.7 | 52.7 |
| 100 | 1175 | 1175 | 65.3 | 60.7 |

Bleed Valve Open

| | | Surge | | |
|---|---|---|---|---|
| | TET | TET/Theta | Generator | Inverter |
| % Speed | (F) | (F) | Power | Power |
| <55 | 1175 | 1020 | | |
| 55 | 1175 | 1020 | 3.0 | 2.8 |
| 60 | 1175 | 1020 | 4.8 | 4.5 |
| 65 | 1175 | 1050 | 7.4 | 6.9 |
| 70 | 1175 | 1075 | 11.1 | 10.3 |
| 75 | 1175 | 1100 | 15.9 | 14.8 |
| 80 | 1175 | — | 27.3 | 25.4 |
| 85 | 1175 | — | 39.1 | 36.4 |
| 90 | 1175 | — | 47.5 | 44.2 |
| 95 | 1175 | — | 56.7 | 52.7 |
| 100 | 1175 | — | 65.3 | 60.7 |

In a multi-plane, multi-injector system, two sets of injector switch points may also be required for when the bleed valve is enabled and disabled. The baseline injector switch points may be a group of referred generator power levels at which the controller enables and disables the injectors when the bleed valve is disabled. A second set of referred generator power levels may be provided for enabling and disabling injectors when the bleed valve is enabled by taking into account the reduction in airflow through the combustion system to provide a stable AFR.

Having now described the invention in accordance with the requirements of the patent statutes, those skilled in the art will understand how to make changes and modifications to the present invention to meet their specific requirements or conditions. Such changes and modifications may be made without departing from the scope and spirit of the invention, as defined and limited solely by the following claims.

What is claimed is:

1. A method of operating a turbogenerator to provide a varying amount of power, the turbogenerator having an air compressor rotationally coupled to a turbine, the method comprising:
controlling turbogenerator speed to provide the required amount of power;
controlling air flow through the turbine inlet to prevent the compressor from stalling by venting a portion of the compressor output while the turbogenerator speed is between a predetermined lower surge value and a predetermined upper surge value; and
controlling the turbine exit temperature to a value derived as a function of turbogenerator speed and ambient conditions to maintain the required air flow.

2. The method of claim 1, wherein controlling the turbine exit temperature comprises:
controlling the turbine exit temperature in accordance with a first function of turbogenerator speed and ambient conditions while venting compressor output; and
controlling the turbine exit temperature in accordance with a second function of turbogenerator speed and ambient conditions while not venting compressor output.

3. The method of claim 2, wherein controlling the turbine exit temperature comprises:
selecting the first function or the second function;
comparing the temperature value indicated by the selected function with a temperature value indicated by a desired turbine exit temperature function of turbogenerator speed and ambient conditions, the desired temperature function for indicating a maximum turbine exit temperature; and
controlling the turbine exit temperature to the lower of the value returned by the selected function and the value returned by the desired temperature function.

4. The method of claim 2, wherein venting a portion of the compressor output comprises:
commencing to vent the compressor output when the turbogenerator speed rises past the lower surge value; and
continuing to vent the compressor output until the turbogenerator speed falls below a predetermined lower safety value, the lower safety value being less than the lower surge value.

5. The method of claim 4, wherein controlling the turbine exit temperature comprises:
selecting the first function or the second function;
comparing the temperature value indicated by the selected function with a temperature value indicated by a desired turbine exit temperature function of turbogenerator speed and ambient conditions, the desired temperature function for indicating a maximum turbine exit temperature; and
controlling the turbine exit temperature to the lower of the value returned by the selected function and the value returned by the desired temperature function.

6. The method of claim 2, wherein venting a portion of the compressor output comprises:
commencing to vent the compressor output when the turbogenerator speed falls below the upper surge value; and
continuing to vent the compressor output until the turbogenerator speed rises above a predetermined upper safety value, the upper safety value being higher than the upper surge value.

7. The method of claim 6, wherein controlling the turbine exit temperature comprises:
selecting the first function or the second function;
comparing the temperature value indicated by the selected function with a temperature value indicated by a desired turbine exit temperature function of turbogenerator speed and ambient conditions, the desired temperature function for indicating a maximum turbine exit temperature; and
controlling the turbine exit temperature to the lower of the value returned by the selected function and the value returned by the desired temperature function.

8. The method of claim 2, wherein the turbogenerator includes a combustor having a plurality of fuel and air injectors and wherein controlling the turbine exit temperature comprises:
selectively providing fuel and air through one or more of the injectors to maintain a selected air-to-fuel ratio in the combustor.

9. The method of claim 8, wherein controlling the turbine exit temperature comprises:
selecting the first function or the second function;
comparing the temperature value indicated by the selected function with a temperature value indicated by a desired turbine exit temperature function of turbogenerator speed and ambient conditions, the desired temperature function for indicating a maximum turbine exit temperature; and
controlling the turbine exit temperature to the lower of the value returned by the selected function and the value returned by the desired temperature function.

10. The method of claim 8, wherein venting a portion of the compressor output comprises:
commencing to vent the compressor output when the turbogenerator speed rises past the lower surge value; and
continuing to vent the compressor output until the turbogenerator speed falls below a predetermined lower safety value, the lower safety value being less than the lower surge value.

11. The method of claim 10, wherein controlling the turbine exit temperature comprises:
selecting the first function or the second function;
comparing the temperature value indicated by the selected function with a temperature value indicated by a desired turbine exit temperature function of turbogenerator speed and ambient conditions, the desired temperature function for indicating a maximum turbine exit temperature; and
controlling the turbine exit temperature to the lower of the value returned by the selected function and the value returned by the desired temperature function.

12. The method of claim 8, wherein venting a portion of the compressor output comprises:
commencing to vent the compressor output when the turbogenerator speed falls below the upper surge value; and
continuing to vent the compressor output until the turbogenerator speed rises above a predetermined upper safety value, the upper safety value being higher than the upper surge value.

13. The method of claim 12, wherein controlling the turbine exit temperature comprises:
selecting the first function or the second function;
comparing the temperature value indicated by the selected function with a temperature value indicated by a desired turbine exit temperature function of turbogenerator speed and ambient conditions, the desired temperature function for indicating a maximum turbine exit temperature; and
controlling the turbine exit temperature to the lower of the value returned by the selected function and the value returned by the desired temperature function.

14. The method of claim 3, wherein the turbogenerator includes a combustor having a plurality of fuel and air injectors and wherein controlling the turbine exit temperature comprises:
selectively providing fuel and air through one or more of the injectors to maintain a selected air-to-fuel ratio in the combustor.

15. A turbogenerator system, comprising:
a turbine driven by hot gas;
a combustor for combusting fuel and compressed air to generate the hot gas;
an air compressor rotationally coupled to the turbine to provide the compressed air;
a bleed valve connected to the compressor discharge to vent a selectable portion of the compressed air while the turbogenerator speed is between a predetermined lower surge value and a predetermined upper surge value to prevent the compressor from stalling; and
a controller for controlling turbogenerator speed to provide a required amount of power, controlling the bleed valve to maintain a required airflow through the turbine inlet, and controlling the turbine exit temperature to a value derived as a function of turbogenerator speed and ambient conditions.

16. The system of claim 15, wherein the combustor comprises:
a plurality of fuel and air injectors for selectively providing fuel and air to maintain a selected air-to-fuel ratio in the combustor.

17. The system of claim 15, wherein the controller comprises:
a controller for controlling the turbine exit temperature to a value derived in accordance with a first function of turbogenerator speed and ambient conditions while the bleed valve is venting compressed air and controlling the turbine exit temperature in accordance with a second function of turbogenerator speed and ambient conditions while the bleed valve is not venting compressed air.

18. The system of claim 17, wherein the controller comprises:
a controller for selecting the first function or the second function and controlling the turbine exit temperature to the lower of the value indicated by the selected function and the value returned by a desired temperature function, the desired temperature function for indicating a maximum turbine exit temperature.

19. The system of claim 15, wherein the controller comprises:
a controller for controlling the bleed valve to vent compressed air when the turbogenerator speed rises past the lower surge value and to continue to vent compressed air until the turbogenerator speed falls below a predetermined lower safety value, the lower safety value being less than the lower surge value.

20. The system of claim 15, wherein the controller comprises:
a controller for controlling the bleed valve to vent compressed air when the turbogenerator speed falls below the upper surge value and to continue to vent compressed air until the turbogenerator speed rises above a predetermined upper safety value, the upper safety value being higher than the upper surge value.
